(19) United States
(12) Patent Application Publication
(10) Pub. No.: US 2024/0253697 A1
(43) Pub. Date: Aug. 1, 2024

(54) STEERING SYSTEM FOR VEHICLE

(71) Applicants: HONDA MOTOR CO., LTD., Minato-ku, Tokyo (JP); Thyssenkrupp Presta Aktiengesellschaft, Eschen (LI)

(72) Inventors: Yosuke OJIMA, Tokyo (JP); Munetsugu HANJI, Tokyo (JP); Takaya YAMAGUCHI, Tokyo (JP); Aranyi MIKLOS, Rebstein (CH); Szepessy IMRE, Mauren (LI); Kocsor MATE, Budapest (HU); Beko MARIA, Kimle (HU); Toth ANDRAS, Gyal (HU); Bodnar BENCE, Kiskunfelegyhaza (HU); Gyokeres JENO, Budapest (HU)

(21) Appl. No.: 18/564,342

(22) PCT Filed: Jul. 19, 2022
(86) PCT No.: PCT/JP2022/027963

§ 371 Date: Nov. 27, 2023

(30) Foreign Application Priority Data
Jul. 20, 2021 (WO) PCT/JP2021/027209

(51) Int. Cl. B62D 5/04

(52) U.S. Cl. CPC B62D 5/0481

(57) ABSTRACT

Provided is a steering system for a vehicle that can accurately determine a degradation level of a steering actuator according to a traveling state of the vehicle. The steering system for the vehicle includes; a steering mechanism configured to steer wheels; a steering actuator configured to apply a driving force to the steering mechanism; and a controller configured to control the steering actuator. The steering mechanism includes a rack shaft that is movable in a vehicle width direction from a prescribed reference position. The controller is configured to calculate an evaluation value according to a use state of the steering actuator and to determine a degradation level of the steering actuator by comparing the evaluation value with at least one threshold that is set based on a moving amount of the rack shaft from the reference position and a vehicle speed.

### TECHNICAL FIELD

The present invention relates to a steering system for a vehicle.

### BACKGROUND ART

Conventionally, there is a steering system for a vehicle including a steering mechanism configured to steer wheels and a steering actuator configured to apply a driving force to the steering mechanism.

For example, Patent Literature 1 discloses an electric power steering system including a rack shaft to which a pair of wheels are connected, a steering shaft provided with a pinion gear that meshes with the rack shaft, and a motor configured to rotate the steering shaft.

### CITATION LIST

### Patent Literature

[Patent Literature 1] JP2018-85917A

### SUMMARY OF INVENTION

### Technical Problem

In a steering system for a vehicle as described above, the steering actuator may be degraded for various reasons. The degradation of the steering actuator may mean the decrease in the maximum output of the steering actuator. To take appropriate measures against the degradation of the steering actuator, it is necessary to accurately determine a degradation level of the steering actuator according to a traveling state of the vehicle.

In view of the above background, an object of the present invention is to accurately determine the degradation level of the steering actuator according to the traveling state of the vehicle.

### Solution of Problem

To achieve such an object, one aspect of the present invention provides a steering system (1) for a vehicle (2), including: a steering mechanism (11) configured to steer wheels (3); a steering actuator (12) configured to apply a driving force to the steering mechanism; and a controller (15) configured to control the steering actuator, wherein the steering mechanism includes a rack shaft (26) that is movable in a vehicle width direction from a prescribed reference position, and the controller is configured to calculate an evaluation value (step ST1) according to a use state of the steering actuator and to determine a degradation level of the steering actuator (step ST4) by comparing the evaluation value with at least one threshold (TH1 to TH3) that is set based on a moving amount of the rack shaft from the reference position and a vehicle speed (step ST2).

According to this aspect, the threshold can be set to an appropriate value based on the moving amount of the rack shaft from the reference position and the vehicle speed, which change according to a traveling state of the vehicle. Accordingly, the degradation level of the steering actuator can be determined accurately according to the traveling state of the vehicle.

In the above aspect, preferably, the at least one threshold comprises a plurality of thresholds, and the controller is configured to determine the degradation level of the steering actuator by comparing the evaluation value with the plurality of thresholds.

According to this aspect, the degradation level of the steering actuator can be classified more finely, so that the degradation level of the steering actuator can be determined more accurately.

In the above aspect, preferably, the controller is configured to regularly determine the degradation level of the steering actuator and to output a signal indicating that the degradation level of the steering actuator is equal to or higher than a prescribed level (step ST6) only if determination that the degradation level of the steering actuator is equal to or higher than the prescribed level is made in succession for a prescribed period or more or for a prescribed number of times or more (step ST5).

According to this aspect, in a case where the degradation level of the steering actuator accidentally reaches or exceeds the prescribed level, it is possible to prevent the output of the signal indicating that the degradation level of the steering actuator is equal to or higher than the prescribed level. Accordingly, erroneous detection of the degradation level of the steering actuator can be prevented.

In the above aspect, preferably, the controller is configured to determine the degradation level of the steering actuator higher in a case where the evaluation value is higher than the threshold than in a case where the evaluation value is equal to or lower than the threshold, and in a case where the vehicle speed is lower than a prescribed reference speed, the threshold is set to become higher as the moving amount of the rack shaft from the reference position increases.

In general, the force required to move the rack shaft (the force required to steer the wheels) increases as the moving amount of the rack shaft from the reference position increases. As such, in a case where the vehicle speed is lower than the reference speed, the threshold becomes higher as the moving amount of the rack shaft from the reference position increases, so that the degradation level of the steering actuator can be determined more accurately.

In the above aspect, preferably, in a case where the vehicle speed is equal to or higher than the reference speed, the threshold is set to a constant value regardless of the moving amount of the rack shaft from the reference position.

When the vehicle is traveling, a restoring force toward the reference position is applied to the rack shaft according to the alignment (especially the caster angle) of the wheels. In general, the effect of such a restoring force is greater than the effect of an increase in the force required to move the rack shaft. As such, the threshold is set to a constant value in a case where the vehicle speed is equal to or higher than the reference speed, so that the degradation level of the steering actuator can be determined more accurately.

In the above aspect, preferably, in a case where a moving speed of the rack shaft is equal to or higher than a prescribed determination suspension speed, the controller suspends a determination of the degradation level of the steering actuator (step ST3).

In a case where the moving speed of the rack shaft is high, the evaluation value may become higher than the threshold even if the steering actuator is not degraded. In consideration of this point, in a case where the moving speed of the rack shaft is equal to or higher than the determination suspension speed, the determination of the degradation level of the steering actuator is suspended, so that erroneous determination of the degradation level of the steering actuator can be prevented. For example, “suspends a determination of the degradation level of the steering actuator” means “puts a determination of the degradation level of the steering actuator on hold during the prescribed period or the prescribed number of times.

In the above aspect, preferably, the controller is configured to determine the degradation level of the steering actuator higher in a case where the evaluation value is higher than the threshold than in a case where the evaluation value is equal to or lower than the threshold, and the evaluation value is set to become higher as a value of an electric current that flows according to drive of the steering actuator increases.

When the frictional resistance inside the steering actuator and/or the force required to move the rack shaft becomes excessive, the driving torque of the steering actuator increases, and the value of the electric current that flows according to drive of the steering actuator also increases. By making the evaluation value high according to such an increase, the degradation level of the steering actuator can be determined accurately.

In the above aspect, preferably, the steering system for the vehicle further includes a temperature sensor (37) configured to detect a temperature of the steering actuator or the controller, wherein the controller is configured to determine the degradation level of the steering actuator higher in a case where the evaluation value is higher than the threshold than in a case where the evaluation value is equal to or lower than the threshold, and in a case where the temperature detected by the temperature sensor is higher than a prescribed reference temperature, the evaluation value is set to become higher as the temperature detected by the temperature sensor becomes higher.

In a case where the temperature of the steering actuator or the controller is excessively high, the maximum output of the steering actuator may be limited to protect the steering actuator or the controller. By making the evaluation value high according to such limitation, the degradation level of the steering actuator can be determined accurately.

In the above aspect, preferably, the steering system further includes a battery (35) configured to supply electric power to the steering actuator, wherein the controller is configured to determine the degradation level of the steering actuator higher in a case where the evaluation value is higher than the threshold than in a case where the evaluation value is equal to or lower than the threshold, and in a case where a voltage of the battery is lower than a prescribed reference voltage, the evaluation value is set to become higher as the voltage of the battery becomes lower.

In a case where the voltage of the battery is excessively low, the maximum output of the steering actuator may be limited to prevent the steering system from shutting down. By making the evaluation value high according to such limitation, the degradation level of the steering actuator can be determined accurately.

In the above aspect, preferably, the evaluation value is determined using a torque utilization value (TU).

According to this aspect, the torque utilization value is calculated based on the outputted torque of the steering actuator.

In the above aspect, preferably, the steering system further includes a steering member (10) configured to receive a steering operation, wherein the steering mechanism is mechanically separated from the steering member.

According to this aspect, in a steer-by-wire steering system, the degradation level of the steering actuator can be determined accurately according to the traveling state of the vehicle.

### Advantageous Effects of Invention

Thus, according to the above aspects, it is possible to accurately determine the degradation level of the steering actuator according to the traveling state of the vehicle.

### BRIEF DESCRIPTION OF DRAWINGS

FIG. 1 a schematic diagram showing a steering system according to an embodiment of the present invention

FIG. 2 a block diagram showing the steering system according to the embodiment of the present invention

FIG. 3 a flowchart showing level determining control according to the embodiment of the present invention

FIG. 4A a graph showing a relationship between a detected temperature and Ilim

FIG. 4B a graph showing a relationship between a battery voltage and Ilim

FIG. 5 a diagram showing a first threshold table

FIG. 6 a table showing a relationship between the range of PU and the degradation level of a steering actuator

FIG. 7 a table showing whether the PU becomes higher than the first threshold, when the degradation level of the steering actuator is a first level

### DESCRIPTION OF EMBODIMENTS

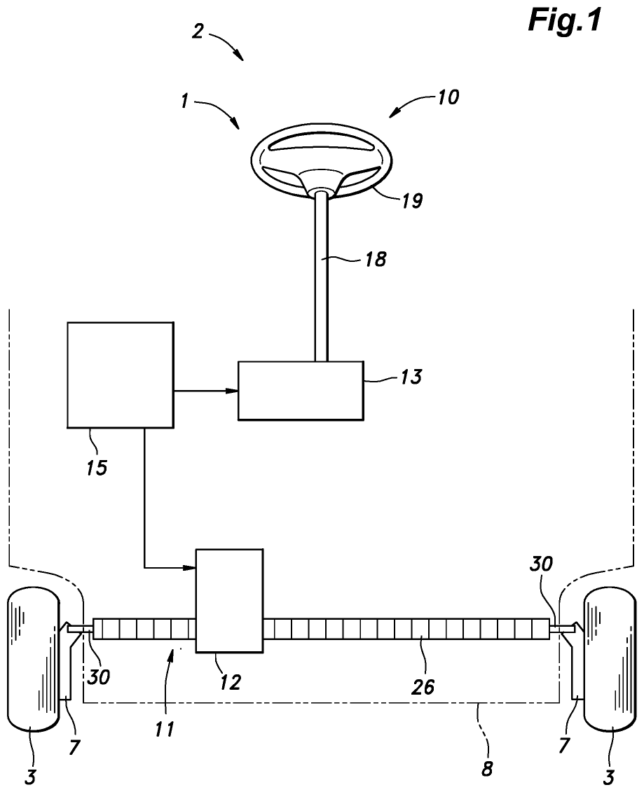

In the following, a steering system 1 for a vehicle 2 according to an embodiment of the present invention will be described. As shown in FIG. 1, the steering system 1 consists of a steer-by-wire (SBW) steering system. The vehicle 2 provided with the steering system 1 is a four-wheeled vehicle including left and right front wheels 3 and left and right rear wheels (not shown in the drawings). The left and right front wheels 3 are supported by a vehicle body 8 (only the outline of a lower part thereof is shown in FIG. 1) via respective knuckles 7 so that the steering angle of the front wheels 3 can be changed, and the front wheels 3 thus serve as steerable wheels. The steering angle refers to the angle of the front wheels 3 with respect to the front-and-rear direction in a plan view. The steering system 1 thus changes the steering angle of the front wheels 3.

The steering system 1 includes a steering member 10 rotatably provided on the vehicle body 8, a steering mechanism 11 configured to steer the front wheels 3, a steering actuator 12 configured to apply a driving force to the steering mechanism 11, a reaction force actuator 13 configured to apply a reaction torque to the steering member 10, and a steering controller 15 configured to control the reaction force actuator 13 and the steering actuator 12. The steering system 1 may be a redundant system that includes a plurality of steering actuators 12, a plurality of reaction force actuators 13, and a plurality of steering controllers 15.

The steering member 10 is configured to receive a steering operation by a driver. The steering member 10 includes a steering shaft 18 rotatably supported by the vehicle body 8 and a steering wheel 19 provided at an end of the steering shaft 18. The steering shaft 18 is rotatably supported by a steering column (not shown in the drawings) provided on the vehicle body 8, and has a rear end projecting rearward from the steering column. The steering wheel 19 is connected to the rear end of the steering shaft 18 so as to rotate integrally with the steering shaft 18.

The reaction force actuator 13 consists of an electric motor, and is connected to the steering shaft 18 via a gear mechanism. When the reaction force actuator 13 is driven, the driving force thereof is transmitted to the steering shaft 18 as a rotational force. The reaction force actuator 13 is configured to rotate and thus to apply torque to the steering member 10. The torque the reaction force actuator 13 applies to the steering member 10 in response to the steering operation is called “reaction torque”.

The steering mechanism 11 includes a rack shaft 26 extending in the vehicle width direction. The rack shaft 26 is supported by a gear housing (not shown in the drawings) such that the rack shaft 26 is movable in the vehicle width direction. The left and right ends of the rack shaft 26 are connected to knuckles 7 that respectively support the left and right front wheels 3 via tie rods 30. As the rack shaft 26 moves in the vehicle width direction from a prescribed reference position (a position where the direction of the left and right front wheels 3 are parallel to the front-and-rear direction: see FIG. 1), the steering angle of the front wheels 3 changes. The steering mechanism 11 is mechanically separated from the steering member 10.

The steering actuator 12 consists of an electric motor. The steering actuator 12 moves the rack shaft 26 in the vehicle width direction based on a signal from the steering controller 15, thereby changing the steering angle of the left and right front wheels 3.

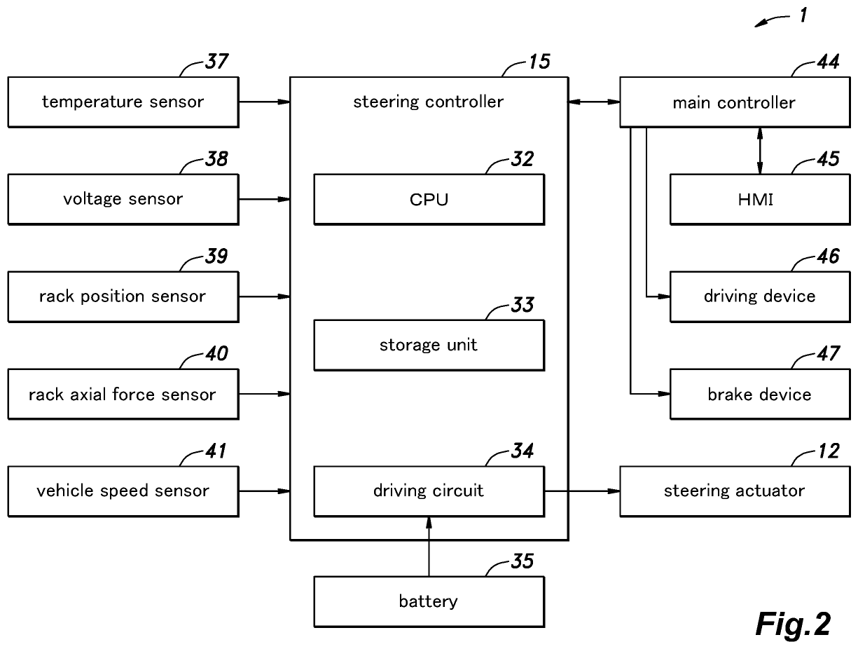

With reference to FIG. 2, the steering controller 15 consists of an electronic control unit (ECU) including a CPU 32, a storage unit 33, a driving circuit 34, and the like. The CPU 32 is configured to control each part of the steering system 1 based on the program and data stored in the storage unit 33. The driving circuit 34 is connected to a battery 35 configured to supply electric power to the steering actuator 12. A direct current flowing from the battery 35 (hereinafter referred to as “the battery current”) is converted into a three-phase alternating current by the driving circuit 34 and then supplied to the steering actuator 12.

The steering controller 15 is connected to a temperature sensor 37. The temperature sensor 37 may be provided integrally with the steering controller 15, or may be provided separately from the steering controller 15. The temperature sensor 37 is configured to detect the temperature of the CPU 32 or the driving circuit 34 (an example of the temperature of the steering controller 15) and to output the above temperature to the steering controller 15. In another embodiment, the temperature sensor 37 may detect the temperature of the steering actuator 12.

The steering controller 15 is connected to a voltage sensor 38. The voltage sensor 38 is configured to detect the voltage of the battery 35 (hereinafter referred to as “the battery voltage”) and to output the battery voltage to the steering controller 15. For example, the battery voltage is a voltage calculated by subtracting a voltage consumed by a harness connecting the battery 35 and the steering controller 15 from a terminal voltage of the battery 35.

The steering controller 15 is connected to a rack position sensor 39. The rack position sensor 39 is configured to detect the position (hereinafter referred to as “the rack position”) of the rack shaft 26 in the vehicle width direction and to output the rack position to the steering controller 15. The steering controller 15 is configured to calculate a moving amount (hereinafter referred to as “the rack stroke amount”) of the rack shaft 26 in the vehicle width direction from the reference position, the moving speed (hereinafter referred to as “the rack stroke speed”) of the rack shaft 26 in the vehicle width direction, and the steering angle of the front wheels 3 based on the rack position detected by the rack position sensor 39.

The steering controller 15 is connected to a rack axial force sensor 40. The rack axial force sensor 40 is configured to detect a force (hereinafter referred to as “the rack axial force”) applied to the rack shaft 26 in the vehicle width direction and to output the rack axial force to the steering controller 15. For example, the rack axial force sensor 40 is a force sensor such as a piezoelectric sensor or a strain gauge.

The steering controller 15 is connected to a vehicle speed sensor 41. The vehicle speed sensor 41 is configured to detect a vehicle speed (a speed of the vehicle 2) and to output the vehicle speed to the steering controller 15.

The steering controller 15 is connected to a main controller 44. The main controller 44 consists of a plurality of ECUs. The main controller 44 is connected to a Human Machine Interface (HMI) 45 including a display, a speaker, a warning light, or the like, thereby controlling the HMI 45. The main controller 44 is connected to a driving device 46 and a brake device 47, thereby controlling the driving device 46 and the brake device 47. The driving device 46 is a device that applies a driving force to the vehicle 2, and includes an electric motor and/or an internal combustion engine. The brake device 47 is a device that applies a brake force to the vehicle 2, and includes a mechanical brake.

Next, level determining control executed by the steering controller 15 will be described. The level determining control is the control for determining a degradation level of the steering actuator 12. For example, the level determining control is executed regularly after the ignition switch of the vehicle 2 is turned on.

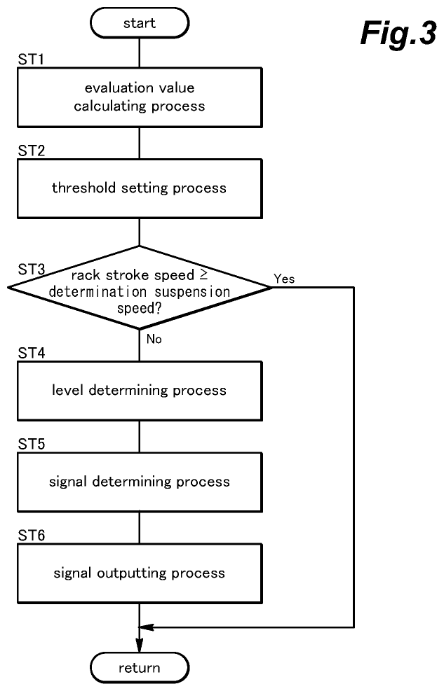

With reference to FIG. 3, when the level determining control is started, the steering controller 15 executes an evaluation value calculating process (step ST1). In the evaluation value calculating process, the steering controller 15 calculates power utilization (hereinafter referred to as “PU”) of the steering actuator 12 based on the following equation (1). PU is an example of an evaluation value according to a use state of the steering actuator 12.

$$PU [ \% ] = \frac{Iact + I max - Ilim}{I max} \cdot 100 \qquad ( 1 )$$

Iact in the above equation (1) is a value of the battery current that actually flows according to the drive of the steering actuator 12. Namely, Iact is a value of the battery current actually consumed according to the drive of the steering actuator 12. Iact is equal to a value calculated by dividing the output of the steering actuator 12 (more specifically, the output of the electric motor constituting the steering actuator 12) by the battery voltage. Iact changes according to a driving state of the steering actuator 12. For example, if the frictional resistance inside the steering actuator 12 or the force required to move the rack shaft 26 in the vehicle width direction becomes excessive, the driving torque of the steering actuator 12 increases, and the Iact increases accordingly. When Iact increases in this way, the numerator of the above equation (1) increases, so that PU becomes higher.

Imax in the above equation (1) is the maximum value of the battery current that flows according to the drive of the steering actuator 12 (namely, the battery current that can be consumed according to the drive of the steering actuator 12), and is determined based on the designed capacity of the steering actuator 12. Imax is constant regardless of the driving state of the steering actuator 12.

Ilim in the above equation (1) is the maximum value of the battery current that flows according to the drive of the steering actuator 12 (namely, the battery current that can be consumed according to the drive of the steering actuator 12), and is determined based on a limitation amount of the maximum output of the steering actuator 12. In a state where the maximum output of the steering actuator 12 is not limited, Ilim is equal to Imax. On the other hand, if the maximum output of the steering actuator 12 is limited for some reason, Ilim becomes smaller than Imax. Namely, Ilim is equal to or smaller than Imax.

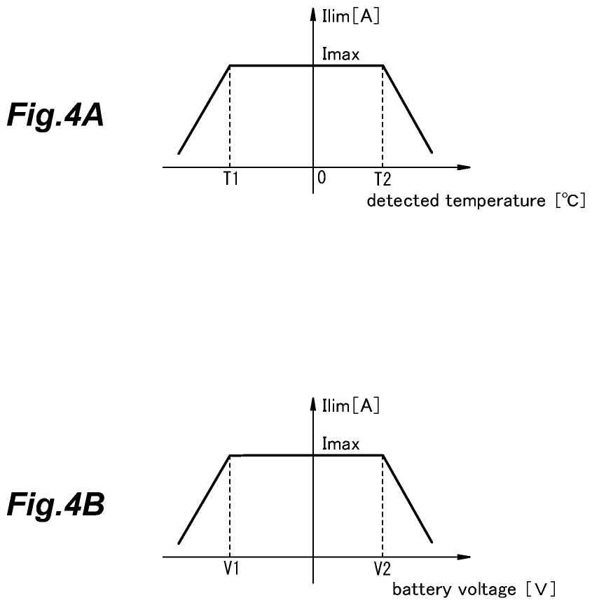

With reference to FIG. 4A, Ilim is determined based on the temperature (hereinafter referred to as “the detected temperature”) of the CPU 32 or the driving circuit 34 detected by the temperature sensor 37. In a case where the detected temperature is equal to or higher than a first reference temperature T1 and equal to or lower than a second reference temperature T2 (T2>T1), Ilim is constant and equal to Imax. In a case where the detected temperature is lower than the first reference temperature T1, Ilim becomes smaller as the detected temperature becomes lower. In a case where the detected temperature is higher than the second reference temperature T2, Ilim becomes smaller as the detected temperature becomes higher. As Ilim becomes smaller in this way, the numerator of the above equation (1) increases, so that PU becomes higher.

With reference to FIG. 4B, Ilim is determined based on the battery voltage detected by the voltage sensor 38. In a case where the battery voltage is equal to or higher than a first reference voltage V1 and equal to or lower than a second reference voltage V2 (V2>V1), Ilim is constant and equal to Imax. In a case where the battery voltage is lower than the first reference voltage V1, Ilim becomes smaller as the battery voltage becomes lower. In a case where the battery voltage is higher than the second reference voltage V2, Ilim becomes smaller as the battery voltage becomes higher. As Ilim becomes smaller in this way, the numerator of the above equation (1) increases, so that PU becomes higher.

With reference to FIG. 3, when the evaluation value calculating process (step ST1) is finished, the steering controller 15 executes a threshold setting process (step ST2). In the threshold setting process, the steering controller 15 sets first to third thresholds TH1 to TH3 based on the rack stroke amount and the vehicle speed.

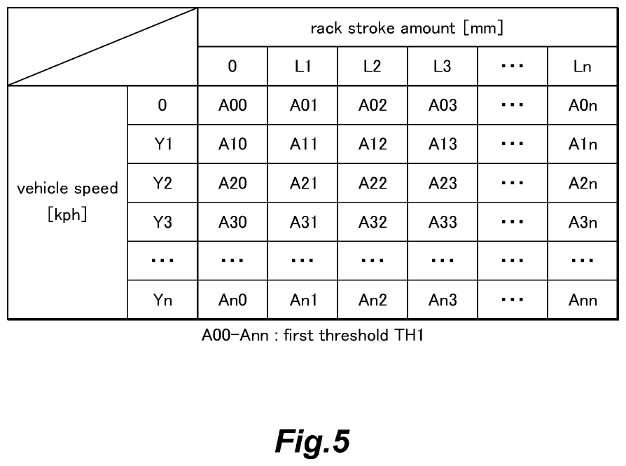

The steering controller 15 determines the first threshold TH1 by referring to a first threshold table (see FIG. 5) based on the rack stroke amount and the vehicle speed. The first threshold table is a two-dimensional table that defines the relationship of the rack stroke amount and the vehicle speed with the first threshold TH1. In the first threshold table, the rack stroke amount increases as the column goes rightward (namely, 0<L1<L2<L3< . . . <Ln). In the first threshold table, the vehicle speed becomes higher as the row goes down (namely, 0<Y1<Y2<Y3< . . . <Yn).

In the first threshold table, A00<A01<A02. Namely, in a case where the vehicle speed is lower than a prescribed reference speed Y1 and the rack stroke amount is less than a prescribed reference amount L3, the first threshold TH1 is set to become higher as the rack stroke amount increases.

In the first threshold table, A02<A03, and A03=A04= . . . =A0n. Namely, in a case where the vehicle speed is lower than the reference speed Y1 and the rack stroke amount is equal to or more than the reference amount L3, the first threshold TH1 is set to a constant value regardless of the rack stroke amount.

The first thresholds TH1 (A10, A11, . . . , Ann) in the second to nth rows of the first threshold table are all the same value. Namely, in a case where the vehicle speed is equal to or more than the reference speed Y1, the first threshold TH1 is set to a constant value regardless of the rack stroke amount. For example, the first thresholds TH1 in the second to nth rows of the first threshold table are higher than A00 (the first threshold TH1 at a time when the vehicle speed and the rack stroke amount are 0) and lower than A03 (the first threshold TH1 at a time when the vehicle speed is 0 and the rack stroke amount is the reference amount L3).

Incidentally, the reference speed Y1 is the second lowest after 0 in the vehicle speed listed in the first threshold table. Accordingly, “a case where the vehicle speed is lower than the reference speed Y1” corresponds to “a case where the vehicle 2 is stopped”, and “a case where the vehicle speed is equal to or higher than the reference speed Y1” corresponds to “a case where the vehicle 2 is traveling”.

The steering controller 15 determines the second and third thresholds TH2 and TH3 by referring to second and third threshold tables (not shown in the drawings) based on the rack stroke amount and the vehicle speed. The second and third threshold tables are similar to the first threshold table, and are two-dimensional tables that define the relationship of the rack stroke amount and the vehicle speed with the second and third thresholds TH2, TH3. In the present embodiment, the second threshold TH2 is higher than the first threshold TH1, and the third threshold TH3 is higher than the second threshold TH2.

With reference to FIG. 3, when the threshold setting process (step ST2) is finished, the steering controller 15 executes a speed determining process (step ST3). In the speed determining process, the steering controller 15 calculates the rack stroke speed based on the rack position detected by the rack position sensor 39, and determines whether the rack stroke speed is equal to or higher than a prescribed determination suspension speed. In a case where the rack stroke speed is equal to or higher than the determination suspension speed (step ST3: Yes), the steering controller 15 does not execute a level determining process (step ST4) and its following steps.

On the other hand, in a case where the rack stroke speed is lower than the determination suspension speed (step ST3: No), the steering controller 15 executes the level determining process (step ST4). In the level determining process, the steering controller 15 determines the degradation level (one of first to fourth levels) of the steering actuator 12 by comparing PU with the first to third thresholds TH1 to TH3.

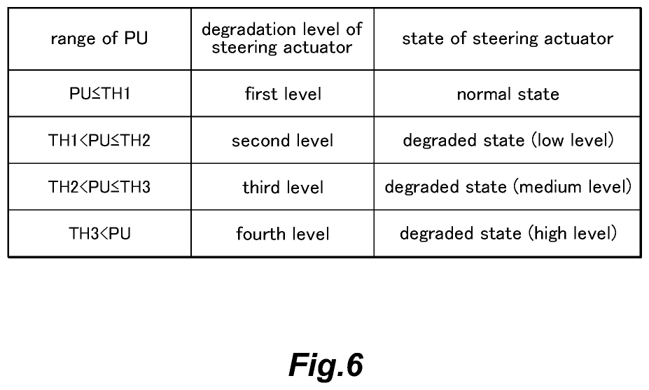

With reference to FIG. 6, in a case where PU is equal to or lower than the first threshold TH1, the steering controller 15 determines that the degradation level of the steering actuator 12 is the first level. The first level is the lowest level among the first to fourth levels, and indicates that the steering actuator 12 is in a normal state.

In a case where PU is higher than the first threshold TH1 and equal to or lower than the second threshold TH2, the steering controller 15 determines that the degradation level of the steering actuator 12 is the second level. The second level is higher than the first level, and indicates that the steering actuator 12 is in a degraded state at a low level.

In a case where PU is higher than the second threshold TH2 and equal to or lower than the third threshold TH3, the steering controller 15 determines that the degradation level of the steering actuator 12 is the third level. The third level is higher than the second level, and indicates that the steering actuator 12 is in a degraded state at a medium level.

In a case where PU is higher than the third threshold TH3, the steering controller 15 determines that the degradation level of the steering actuator 12 is the fourth level. The fourth level is higher than the third level, and indicates that the steering actuator 12 is in a degraded state at a high level.

As described above, the steering controller 15 determines the degradation level of the steering actuator 12 higher in a case where PU is higher than each threshold TH1 to TH3 than in a case where PU is equal to or lower than each threshold TH1 to TH3.

With reference to FIG. 3, when the level determining process (step ST4) is finished, the steering controller 15 executes a signal determining process (step ST5). The signal determining process is a process for determining a signal (hereinafter referred to as “the output signal”) the steering controller 15 outputs to the main controller 44. In the signal determining process, the steering controller 15 determines whether a successive determination period is equal to or longer than a prescribed period by referring to the determination results of the level determining processes in the current and past level determining control. The successive determination period is a period during which the determination that the degradation level of the steering actuator 12 is equal to or higher than the second degradation level (namely, the determination that the steering actuator 12 is not in the normal state) is made in succession. In a case where the successive determination period is equal to or longer than the prescribed period, the steering controller 15 determines one of second to fourth level signals (namely, a signal indicating that the degradation level of the steering actuator 12 is one of the second to fourth levels) as the output signal according to the determination result of the level determining process (step ST4). On the other hand, in a case where the successive determination period is shorter than the prescribed period, the steering controller 15 determines a first level signal (namely, a signal indicating that the degradation level of the steering actuator 12 is the first level) as the output signal regardless of the determination result of the level determining process (step ST4).

When the signal determining process (step ST5) is finished, the steering controller 15 executes a signal outputting process (step ST6). In the signal outputting process, the steering controller 15 outputs the output signal (one of the first to fourth level signals) determined in step ST5 to the main controller 44. In another embodiment, in a case where the successive determination period is shorter than the prescribed period in step ST5, the steering controller 15 may not output a signal to the main controller 44.

The main controller 44 recognizes the degradation level of the steering actuator 12 based on the output signal (one of the first to fourth level signals) from the steering controller 15. In a case where the degradation level of the steering actuator 12 is the first level (namely, in a case where the steering actuator 12 is in the normal state), the main controller 44 does not execute warning control and vehicle speed limit control. On the other hand, in a case where the degradation level of the steering actuator 12 is one of the second to fourth levels (namely, in a case where the steering actuator 12 is in the degraded state), the main controller 44 executes the warning control and/or the vehicle speed limit control.

In the warning control, the main controller 44 causes the HMI 45 to issue a warning that the steering actuator 12 is in the degraded state. For example, the main controller 44 causes the display of the HMI 45 to display a warning message, causes the speaker of the HMI 45 to generate a warning sound, or turns on or blinks the warning light of the HMI 45. The main controller 44 may change the contents of the warning control according to the degradation level (one of the second to fourth levels) of the steering actuator 12.

In the vehicle speed limit control, the main controller 44 controls the driving device 46 and the brake device 47 such that the vehicle speed is equal to or lower than a prescribed speed limit. The main controller 44 may change the speed limit according to the degradation level (one of the second to fourth levels) of the steering actuator 12. For example, the main controller 44 may set the speed limit such that the speed limit becomes lower as the degradation level of the steering actuator 12 becomes higher.

Incidentally, the warning control and the vehicle speed limit control are merely examples of the control the main controller 44 executes according to the degradation level of the steering actuator 12. Accordingly, the main controller 44 may execute any control other than the warning control and the vehicle speed limit control. For example, the main controller 44 may execute emergency stop control to cause the vehicle 2 to autonomously travel to an appropriate stop position and to stop there. Further, a device other than the main controller 44 (for example, the steering controller 15, the driving device 46, and/or the brake device 47) may execute the warning control, the vehicle speed limit control, and the like according to the degradation level of the steering actuator 12.

In the following, regarding the effects common to the first to third thresholds TH1 to TH3, only the effect of the first threshold TH1 will be described, and the description of the effects of the second and third thresholds TH2 and TH3 will be omitted.

In the present embodiment, the first threshold TH1 is set based on the rack stroke amount and the vehicle speed (step ST2). Accordingly, the first threshold TH1 can be set to an appropriate value based on the rack stroke amount and the vehicle speed, which change according to a traveling state of the vehicle. Accordingly, the degradation level of the steering actuator 12 can be determined accurately according to the traveling state of the vehicle.

Further, the steering controller 15 determines the degradation level of the steering actuator 12 by comparing PU with the first to third thresholds TH1 to TH3 (namely, a plurality of thresholds). Accordingly, the degradation level of the steering actuator 12 can be classified more finely, so that the degradation level of the steering actuator 12 can be determined more accurately.

Further, the steering controller 15 regularly determines the degradation level of the steering actuator 12, and outputs the signal indicating that the degradation level of the steering actuator 12 is equal to or higher than the second level (step ST6) only if the determination that the degradation level of the steering actuator 12 is equal to or higher than the second level is made in succession for the prescribed period or more (step ST5). Accordingly, in a case where the degradation level of the steering actuator 12 accidentally reaches or exceeds the second level, it is possible to prevent the output of the signal indicating that the degradation level of the steering actuator 12 is equal to or higher than the second level. Accordingly, erroneous detection of the degradation level of the steering actuator 12 can be prevented.

In general, the force required to move the rack shaft 26 (the force required to steer the front wheels 3) increases as the rack stroke amount increases. In consideration of this point, in a case where the vehicle speed is lower than the reference speed Y1, the first threshold TH1 is set to become higher as the rack stroke amount increases. Accordingly, the degradation level of the steering actuator 12 can be determined more accurately.

When the vehicle is traveling, a restoring force toward the reference position is applied to the rack shaft 26 according to the alignment (especially the caster angle) of the front wheels 3. In general, the effect of such a restoring force is greater than the effect of an increase in the force required to move the rack shaft 26. In consideration of this point, in a case where the vehicle speed is equal to or higher than the reference speed Y1, the first threshold TH1 is set to a constant value. Accordingly, the degradation level of the steering actuator 12 can be determined more accurately.

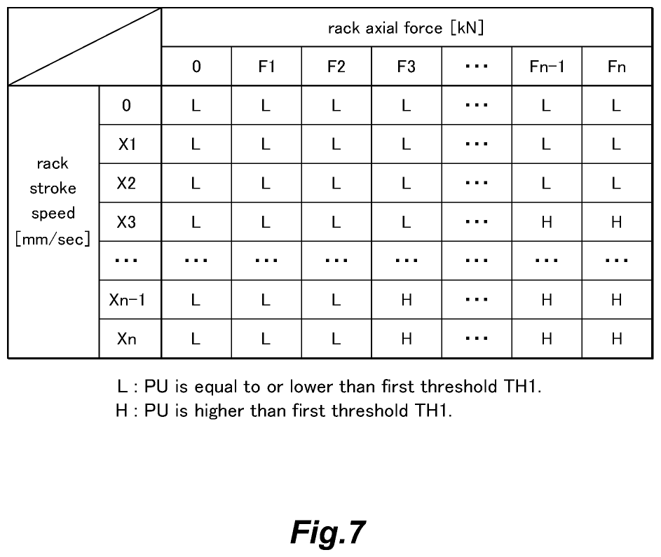

FIG. 7 shows whether PU becomes higher than the first threshold TH1 when the degradation level of the steering actuator 12 is the first level (namely, when the steering actuator 12 is in the normal state). In FIG. 7, the rack axial force increases as the column goes rightward (namely, 0<F1<F2<F3< . . . <Fn−1<Fn). In FIG. 7, the rack stroke speed becomes higher as the row goes down (namely, 0<X1<X2<X3< . . . <Xn−1<Xn).

As shown in FIG. 7, in a case where the rack stroke speed is high, PU may become higher than the first threshold TH1 even if the degradation level of the steering actuator 12 is the first level. In consideration of this point, in a case where the rack stroke speed is equal to or higher than the prescribed determination suspension speed (for example, X3 in FIG. 7), the steering controller 15 suspends a determination of the degradation level of the steering actuator 12 (step ST3). Accordingly, erroneous determination of the degradation level of the steering actuator 12 can be prevented.

For example, when the temperature of the steering actuator 12 drops and grease hardens inside the steering actuator 12, the frictional resistance inside the steering actuator 12 may become excessive. Further, the force required to move the rack shaft 26 may become excessive due to the overload of the vehicle 2 or the like. When these situations occur, the driving torque of the steering actuator 12 increases, and Iact (the value of the battery current that actually flows according to the drive of the steering actuator 12) also increases. In consideration of this point, PU is set to become higher as Iact increases. Accordingly, the degradation level of the steering actuator 12 can be determined more accurately.

In a case where the detected temperature (the temperature of the CPU 32 or the driving circuit 34 detected by the temperature sensor 37) is excessively high, the maximum output of the steering actuator 12 may be limited to protect the CPU 32 or the driving circuit 34. In consideration of this point, in a case where the detected temperature is higher than the second reference temperature T2, PU is set to become higher as the detected temperature becomes higher. Accordingly, the degradation level of the steering actuator 12 can be determined more accurately.

In a case where the battery voltage is excessively low, the maximum output of the steering actuator 12 may be limited to prevent the steering system 1 from shutting down. In consideration of this point, in a case where the battery voltage is lower than the first reference voltage V1, PU is set to become higher as the battery voltage becomes lower. Accordingly, the degradation level of the steering actuator 12 can be determined more accurately.

In the above embodiment, the steering controller 15 calculates PU (the evaluation value) based on the values of the electric currents (Iact, Imax, Ilim). In another embodiment, the steering controller 15 may calculate the evaluation value based on electric power or torque by applying the similar equation as the above equation (1) to electric power or torque. Further, in another embodiment, the steering controller 15 may calculate the evaluation value based on the battery voltage, the surrounding temperature of the steering actuator 12, the temperature of the steering controller 15 or the steering actuator 12, the rack axial force, the frictional resistance inside the steering actuator 12 estimated based on the rack axial force, or the like.

In case the steering controller 15 calculates PU based on electric power, the following equation (2) is used.

$$PU [ \% ] = \frac{Actual Power + Maximum Power - Power Degradation Limit}{Maximum Power} \cdot 100 \qquad ( 2 )$$

Actual Power in the equation (2) means the actual consumed power of the steering actuator 12. Maximum Power in the equation (2) refers to the largest power of the steering actuator 12 on the actual voltage defined by sizing. Power Degradation Limit in the equation (2) is the actual limit settled in the steering actuator 12 to avoid under- or over-voltage or over-temperature of the steering actuator 12.

In case the steering controller 15 calculates the evaluation value based on the output torque of the steering actuator 12, a torque utilization value (TU) is calculated based on the following equations (3) and (4). TU is an example of an evaluation value according to a use state of the steering actuator 12. The evaluation value is determined using TU, and TU is calculated based on the outputted torque of the steering actuator 12.

$$TU [ \% ] = \frac{Mmot\_act + Mdeg}{M max} \cdot 100 \qquad ( 3 )$$

$$Mdeg = MAXIMUM [ ( M max - Mtrq\_limit ) ; ( M max - Mpw\_limit ) ] \qquad ( 4 )$$

Mmot_act in the above equation (3) is the actual torque value of the steering actuator 12. Mtrq_limit in the above equation (4) refers to the maximal torque capability of the steering actuator 12, basically it is the torque limit of the steering actuator 12. Mpw_limit in the above equation (4) also refers to the torque limit of the steering actuator 12 but introducing another constraint, namely the battery power limit. In this case the steering actuator 12 would be able to provide the required amount of torque but the maximum value of the battery current that flows according to the drive of the steering actuator 12 only allows a smaller amount of torque to be outputted by the steering actuator 12. Mmax in the above equations (3) and (4) is the maximum torque value of the steering actuator 12 at its actual speed according to the sizing specification. Mdeg in the above equations (3) and (4) is representing a value of the actual torque degradation, which is determined using a selection. The torque limits Mtrq_limit and Mpw_limit are each subtracted separately from the maximum torque value Mmax. The greater value of these subtractions will be used in equation (3) as Mdeg.

In the above embodiment, in the signal determining process (step ST5), the steering controller 15 determines whether the successive determination period is equal to or longer than the prescribed period. In another embodiment, in the signal determining process, the steering controller 15 may determine whether a successive determination number of times is equal to or more than a prescribed number of times. The successive determination number of times is the number of times for which the determination that the degradation level of the steering actuator 12 is equal to or higher than the prescribed level is made in succession.

In the above embodiment, the steering controller 15 sets three thresholds. In another embodiment, the steering controller 15 may set only one threshold, two thresholds, or four or more thresholds. For example, the steering controller 15 may determine that the steering actuator 12 is in the degraded state in a case where PU (the evaluation value) is higher than the one threshold, and may determine that the steering actuator 12 is not in the degraded state in a case where PU is equal to or lower than the one threshold. In this way, “determination of the degradation level of the steering actuator 12” includes “determination of whether the steering actuator 12 is in the degraded state”.

In the above embodiment, PU (the evaluation value) is set to become higher as the degradation level of the steering actuator 12 becomes higher. In another embodiment, the evaluation value may be set to become lower as the degradation level of the steering actuator 12 becomes higher. In this embodiment, the steering controller 15 may determine the degradation level of the steering actuator 12 higher in a case where the evaluation value is lower than the threshold than in a case where the evaluation value is equal to or higher than the threshold.

In the above embodiment, the steering controller 15 calculates the rack stroke amount based on the rack position detected by the rack position sensor 39. In another embodiment, the steering controller 15 may calculate the rack stroke amount based on the steering angle of the front wheels 3, the lateral acceleration applied to the vehicle 2, the yaw rate, and/or the vehicle speed.

In the above embodiment, the steering controller 15 suspends the determination of the degradation level of the steering actuator 12 in a case where the rack stroke speed is equal to or higher than the prescribed determination suspension speed. In another embodiment, the steering controller 15 may suspend the determination of the degradation level of the steering actuator 12 in a case where the rack axial force is equal to or higher than a prescribed determination suspension force.

In the above embodiment, the steering controller 15 directly acquires the rack axial force from the rack axial force sensor 40. In another embodiment, the steering controller 15 may estimate the rack axial force based on the evaluation value such as PU or the value of the electric current of the steering actuator 12 (for example, the effective value of the three-phase alternating current flowing through the steering actuator 12). In the latter case, the steering controller 15 may estimate the rack axial force by multiplying the value of the electric current of the steering actuator 12 by a power transmission coefficient (a coefficient set based on the power transmission efficiency from the steering actuator 12 to the rack shaft 26).

In the above embodiment, the configuration of the present invention is applied to a steering system 1 (more specifically, a steer-by-wire steering system 1) in which the steering mechanism 11 is mechanically separated from the steering member 10. In another embodiment, the configuration of the present invention may be applied to a steering system 1 in which the steering mechanism 11 is mechanically connected to the steering member 10.

Concrete embodiments of the present invention have been described in the foregoing, but the present invention should not be limited by the foregoing embodiments and various modifications and alterations are possible within the scope of the present invention.

### REFERENCE SIGNS LIST

1: steering system
2: vehicle
3: front wheels (an example of wheels)
10: steering member
11: steering mechanism
12: steering actuator
15: steering controller (an example of a controller)
26: rack shaft
35: battery
37: temperature sensor

What is claimed is:

1. A steering system for a vehicle, comprising:
a steering mechanism configured to steer wheels;
a steering actuator configured to apply a driving force to the steering mechanism; and
a controller configured to control the steering actuator,
wherein the steering mechanism includes a rack shaft that is movable in a vehicle width direction from a prescribed reference position, and
the controller is configured to calculate an evaluation value according to a use state of the steering actuator and to determine a degradation level of the steering actuator by comparing the evaluation value with at least one threshold that is set based on a moving amount of the rack shaft from the reference position and a vehicle speed.

2. The steering system for the vehicle according to claim 1, wherein the at least one threshold comprises a plurality of thresholds, and
the controller is configured to determine the degradation level of the steering actuator by comparing the evaluation value with the plurality of thresholds.

3. The steering system for the vehicle according to claim 1, wherein the controller is configured to regularly determine the degradation level of the steering actuator and to output a signal indicating that the degradation level of the steering actuator is equal to or higher than a prescribed level only if determination that the degradation level of the steering actuator is equal to or higher than the prescribed level is made in succession for a prescribed period or more or for a prescribed number of times or more.

4. The steering system for the vehicle according to claim 1, wherein the controller is configured to determine the degradation level of the steering actuator higher in a case where the evaluation value is higher than the threshold than in a case where the evaluation value is equal to or lower than the threshold, and
in a case where the vehicle speed is lower than a prescribed reference speed, the threshold is set to become higher as the moving amount of the rack shaft from the reference position increases.

5. The steering system for the vehicle according to claim 4, wherein in a case where the vehicle speed is equal to or higher than the reference speed, the threshold is set to a constant value regardless of the moving amount of the rack shaft from the reference position.

6. The steering system for the vehicle according to claim 1, wherein in a case where a moving speed of the rack shaft is equal to or more than a prescribed determination suspension speed, the controller suspends a determination of the degradation level of the steering actuator.

7. The steering system for the vehicle according to claim 1, wherein the controller is configured to determine the degradation level of the steering actuator higher in a case where the evaluation value is higher than the threshold than in a case where the evaluation value is equal to or lower than the threshold, and
the evaluation value is set to become higher as a value of an electric current that flows according to drive of the steering actuator increases.

8. The steering system for the vehicle according to claim 1, further comprising a temperature sensor configured to detect a temperature of the steering actuator or the controller,
wherein the controller is configured to determine the degradation level of the steering actuator higher in a case where the evaluation value is higher than the threshold than in a case where the evaluation value is equal to or lower than the threshold, and
in a case where the temperature detected by the temperature sensor is higher than a prescribed reference temperature, the evaluation value is set to become higher as the temperature detected by the temperature sensor becomes higher.

9. The steering system for the vehicle according to claim 1, further comprising a battery configured to supply electric power to the steering actuator,
wherein the controller is configured to determine the degradation level of the steering actuator higher in a case where the evaluation value is higher than the threshold than in a case where the evaluation value is equal to or lower than the threshold, and
in a case where a voltage of the battery is lower than a prescribed reference voltage, the evaluation value is set to become higher as the voltage of the battery becomes lower.

10. The steering system for the vehicle according to claim 1, wherein the evaluation value is determined using a torque utilization value, and
the torque utilization value is calculated based on outputted torque of the steering actuator.

11. The steering system for the vehicle according to claim 1, further comprising a steering member configured to receive a steering operation,
wherein the steering mechanism is mechanically separated from the steering member.
